(19) United States
(12) Patent Application Publication
(10) Pub. No.: US 2007/0127652 A1
(43) Pub. Date: Jun. 7, 2007

(54) Method and system for processing calls

(76) Inventors: Abha S. Divine, Austin, TX (US); Carol Shifrin Gruchala, Naperville, IL (US)

Correspondence Address: BRINKS HOFER GILSON & LIONE, P.O. BOX 10395, CHICAGO, IL, 60610, US

(21) Appl. No.: 11/291,403

(22) Filed: Dec. 1, 2005

(51) Int. Cl. H04M 15/06; H04M 1/56

(52) U.S. Cl. 379/142.01

(57) ABSTRACT

A privacy management system allows a called party to re-direct picked up calls. A call is suspended if standard calling line identification can not be provided for the call. The caller is prompted to provide audible caller identification which is recorded and replayed to the called party before completing the call. The called party may enter a first input to accept the call based on the audible caller identification. If the called party subsequently determines that the call should be handled by another automatic disposition, the called party can enter a second input to provide a call redirection indication. In response to the call redirection indication, the call is disconnected and redirected to complete between the calling party and a destination such as voice mail or a message which is indicated by the call redirection indication.

### BACKGROUND

The present invention relates generally to telecommunications call processing and more particularly to caller identification and related features.

Telecommunications service providers typically offer services that attempt to provide customers with information that enables them to determine whether or not to accept a call before answering the call. Among these services that provide such information is caller identification (“Caller ID”) and Call waiting. Standard Caller ID services generally provide a customer with an indication of who is calling without requiring the customer to answer the call. These systems typically retrieve information about the calling party from a database and provide that information to the called party. Customer premises equipment (CPE) in the form of a display device is generally used to provide the called party with a visual readout of the name and/or telephone number associated with the calling party.

However, the effectiveness of Caller ID systems can be reduced due to a number of different occurrences. One such occurrence is the inability of a service provider to provide the standard Caller ID information for a particular incoming call. This may occur if the Caller ID information is blocked or the call is marked Private by the calling party, or if the Caller ID information is unavailable or incomplete.

When the standard Caller ID information cannot be provided, the called party is not adequately informed about who is calling and cannot determine whether or not to accept the incoming call before answering the call. Because the effectiveness of Caller ID systems is greatly reduced when information cannot be provided, an improved system and method are needed for providing caller identification information that overcome these deficiencies.

Patent application Ser. No. 09/122,484, filed Jul. 24, 1998 and commonly assigned to the assignee of the present application, is incorporated herein by reference. This patent application discloses a method and system for providing a called party with audible caller identification information when standard caller identification information cannot be provided. This may occur when standard caller identification information is blocked or when the calling party is on a subscriber-designated blocked call list. When standard caller identification information cannot be provided, the call is blocked and a request for audible caller identification information is transmitted to the calling party. The audible information is subsequently transmitted to the called party.

This method and system are effective at processing an incoming call. However, this method and system do not provide for handling of unwanted calls or message-taking once the called party answers the phone.

### BRIEF DESCRIPTION OF THE DRAWINGS

FIG. 1 is a block diagram of a system for processing a telephone call;

FIG. 2 is a more detailed block diagram of the system depicted in FIG. 1;

FIGS. 3-5 are a flow chart illustrating a method for processing a telephone call;

FIG. 6 illustrates a called communication station and adjunct customer premises equipment; and

FIG. 7 is an illustrative embodiment of a general computer system.

### DETAILED DESCRIPTION OF THE PRESENTLY PREFERRED EMBODIMENTS

By way of introduction, the preferred embodiments described below include a method and system for enabling a called party to dispose of unwanted telephone calls. In one embodiment, calls for which standard caller identification information is blocked, unavailable, or incomplete are prevented from being connected to the called party until the calling party provides audible caller identification, which is transmitted to the called party.

After receiving the audible caller identification information, the called party can decide whether to proceed with the call or cancel the call and can indicate their preference by providing an input. In one embodiment, after the audible caller identification information has been transmitted to the called communication station, a message is transmitted to the called communication station. The message preferably includes instructions that allow the called party to accept or reject the call by providing the appropriate input. The message preferably comprises audible instructions that are transmitted to the called communication station. The accept and reject options preferably comprise accepting the call by enabling the connection of the call to the called communication station, canceling the call by disabling the connection of the call to the called communication station, forwarding the call to a voice mail system or another location, and sending a message to the calling party. The message sent to the calling party can comprise a request that the called party be taken off a telemarketer's call list. Each of these options is preferably invoked when the called party provides the appropriate input.

This input can take the form of one or more of the following: hook flash, DTMF tones, dial pulse input, modem/fax input, voice input, or (computer characters). For example, an input can be used to signify the called party's desire to cancel the call, while another input can be used to signify the called party's desire to proceed with the call. In response to this input provided by the called party, network equipment can process the call. Accordingly, the network equipment can connect the call, cancel the call, transmit a message to the calling communication station or forward the call to a voice mail system or another location in response to the input provided by the called party.

Assuming that the called party has decided to proceed with the call and has provided the corresponding first input and after the calling party and the called party have been connected, the called party can then indicate their desire to redirect by providing a second input. The second input can take the form of one or more of the following: flash-hook, DTMF tones, dial pulse input, modem/fax input, voice input, or (computer characters) as known to those skilled in the art. For example, a second input can be used to signify the called party's desire to cancel the call, while another second input can be used to signify the called party's desire send the call to voicemail, and another second input can be used to signify the called party's desire to cancel the call and send a message to the calling party.

In an alternative embodiment, CPE equipment can be provided for use in conjunction with the called communication station that can be used by the called party to provide the second input. In one example, the CPE equipment could include a dedicated communication device that includes three separate buttons that each represent a different action that can be taken in response to activation of that button. For example, activation of the first can cause the call to be cancelled, while activation of the second button can cause the call to be sent to voicemail, and activation of the third button can cause the call to be cancelled and message to be send to the calling party.

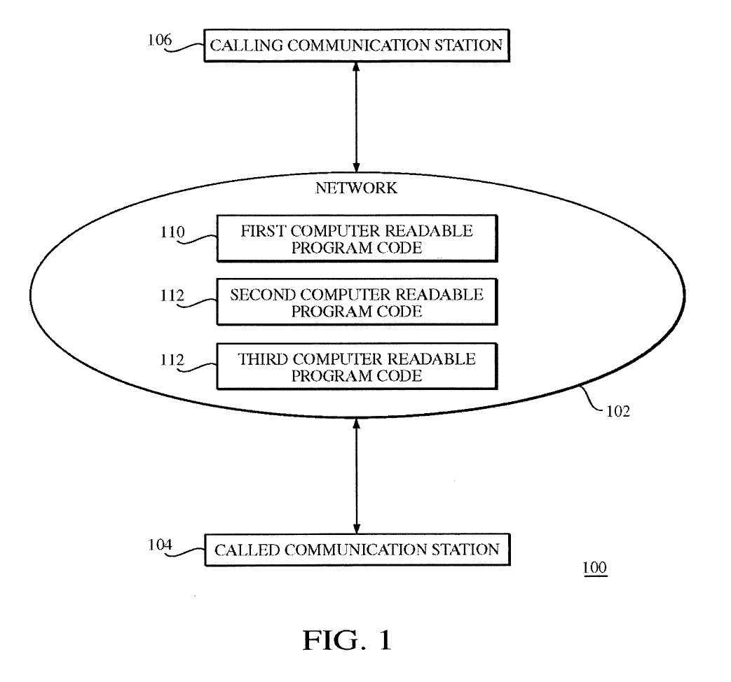

Referring now to the drawing, FIG. 1 depicts a telecommunication system 100 of one preferred embodiment. The system 100 comprises a network 102, a called communication station 104 connected with the network 102 and a calling communication station 106 connected with the network 102.

The network 102 preferably comprises first computer readable program code 110, second computer readable computer program code 112 and third computer readable program code 114. The first computer readable program code 110 forms a means for determining if the called communication station is off hook or on hook. The second computer readable program code 112 forms a means for transmitting an audible call waiting indicator to the called communication station 104 or for ringing the called communication station 104. The third computer readable program code 114 forms a means for providing to the called communication station audible caller identification information using one of standard caller identification information and spoken caller identification information provided by the calling party at the calling communication station 106. It is important to note that while the program codes 110, 112, 114 have been shown as three separate elements, their functionality can be combined and/or distributed. It is also important to note that “medium” is intended to broadly include any suitable medium including analog or digital, hardware or software, now in use or developed in the future.

The system 100 is preferably implemented in a communications network. Alternatively, the system 100 can be implemented in a computer network or any other network that is adapted to store and retrieve information. In yet another alternative, the system 102 or hardware or software components thereof can be implemented at the subscriber's location, for example, in a personal computer and a home local area network (LAN). The system 100 may include other hardware and software components such as other program codes. Each of the computer readable program codes 110, 112, 114 described above is preferably implemented as code written in any suitable programming language and implemented on an analog or digital computer utilizing any suitable operating system as known by those skilled in the art. Alternatively, each of the computer readable program codes 110, 112, 114 can be implemented through the use of hardware in the form of a hardwired computer, an integrated circuit, or a combination of hardware and computer readable program code as known by those skilled in the art. The calling communication station 106 and the called communication station 104 preferably comprise a telephone station as known by those skilled in the art, including both analog and digital telephone equipment. According to an alternative embodiment, the communication stations 104, 106 can comprise any suitable communication station adapted for use in the present embodiments as known by those skilled in the art.

The system 100 enables a customer at the called communication station 104 to be efficiently and effectively notified that a current call from calling communication station 106 is waiting. The system 100 provides audible notification for all incoming calls, whether the call is a current call or a call waiting call which is received while the current call is still in progress. The system 100 provides an enhanced call message that includes both the call waiting indicator and the audible representation of information associated with the calling communication station 106. In the illustrated embodiment, the audible representation is produced from stored standard caller ID with caller name information. The caller name is processed through a text to speech facility to produce the audible representation. If the standard caller identification information can not be provided, the calling party is prompted by the system to state his name as spoken caller identification information. The spoken caller identification information is then provided as the audible caller identification information. The audible caller identification information associated with the calling communication station alerts the customer that the current call is present or waiting and provides the customer with information that assists the customer in deciding whether to take the current call.

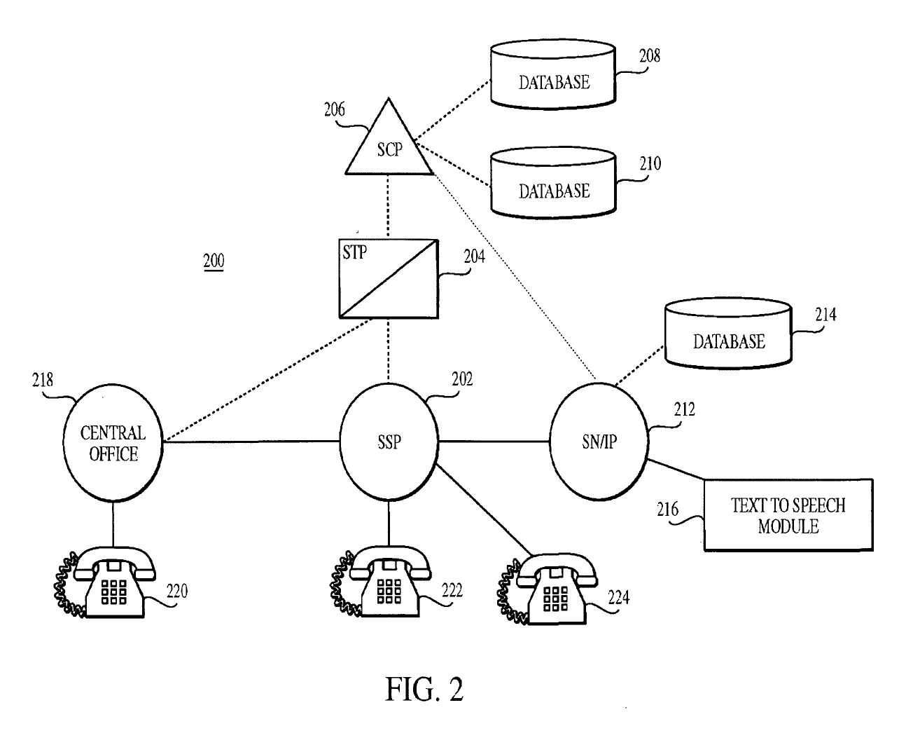

By way of further example, FIG. 2 depicts one embodiment of the system 100 described above. Communication system 200 comprises a service switching point (SSP) 202, a signal transfer point (STP) 204, a service control point (SCP) 206, a first SCP database 208, a second SCP database 210, a service node/intelligent peripheral (SN/IP) 212, a SN/IP database 214, a text to speech module 216, a central office 218, calling communication station 220, a called communication station 220 and a third communication station 222. Intelligent network system components, commonly referred to as advanced intelligent network (AIN) components, suitable for implementing the present embodiment are commercially available from several vendors and are known to those skilled in the art. AIN components can implement computer readable program code. Vendors of AIN components typically have a preferred programming language and operating platform.

SSP 202 preferably comprises an AIN switch that routes calls, recognizes and responds to triggers, generates queries to obtain call information and responds to returned call information. SSP 202 connects called communication station 222 with central office 218 to enable a call to be placed between called communication station 222 and calling communication station 220. SSP 202 further connects called communication station 222 with third communication station 224 to complete a call between called communication station 222 and third communication station 224. SSP 202 preferably communicates with SCP 204, central office 218 and SNIP 212 by utilizing a signaling protocol such as Signaling System 7 (SS7) or other such signaling protocols as presently known to those skilled in the art or developed in the future. SSP 202 preferably generates queries to SCP 204 and receives and responds to responses returned from SCP 204.

STP 204 preferably comprises a network element that transfers signaling communications in response to signaling protocols such as SS7 or other such signaling protocols as presently known to those skilled in the art or developed in the future. STP 204 preferably transfers queries from SSP 202 to SCP 206 and transfers responses to the queries from SCP 206 to SSP 202.

SCP 206 preferably comprises an AIN element that stores call information and receives and responds to queries. SCP 206 preferably stores call control information in the first SCP database 208 and can access the stored call control information. SCP 206 also stores standard caller identification information in the second SCP database 210 and can access the stored caller identification information. SCP 206 receives queries generated by SSP 202 and preferably responds to the queries by performing database searches to locate the requested call control information or caller identification information as known to those skilled in the art. SCP 206 can forward the call control information or caller identification information to SSP 202.

SN/IP 212 preferably comprises a network element that enables communications between communication stations 220, 222, 224 and the network. In one embodiment, SN/IP 212 comprises a service node. In another embodiment, SN/IP 212 comprises an intelligent peripheral. Both a service node and an intelligent peripheral are well-known components of an AIN network. In other networks, SN/IP 212 may comprise other components suitable for performing the functions described below. In FIG. 2, a dotted line connection is shown between the SN/IP 212 and the SCP 206 to indicate communication of data, instructions and other information between the SN/IP 212 and the SCP 206.

SN/IP 212 can preferably transmit messages to and receive responses from communication stations 220, 222, 224. SN/IP 212 can generate announcements that can be transmitted to communication stations 220, 222, 224. SN/IP 212 can transmit responses such as audible caller identification information from communication station 220 to communication station 222 by connecting communication stations 220, 222 or by recording and playing back the responses. The announcements transmitted to communication station 222 preferably comprise accept and reject options along with requests for input from the communication station 222. The requests for input preferably comprise requests for input that can be used by SN/IP 212 to cancel calls to communication station 222, connect calls to communication station 222, forward calls to a voice messaging system or another location such as another telephone line, and transmit messages to communication station 220. As used herein, the term voice messaging system means all types of message recording systems as known to those skilled in the art. SN/IP 212 can preferably receive and respond to the input transmitted from communication station 222. The term input means any suitable signal such as DTMF tones, voice input, dial pulse input or modem/fax input as known to those skilled in the art.

Databases 208, 210 preferably comprise data storage elements for use with SCP 206. Databases 208, 210 preferably store call control information that can be implemented by SSP 202 to control calls. Such call control information is known to those skilled in the art. While databases 208, 210 are shown in FIG. 2 as two separate databases, in particular applications, they may be combined into a single database or arranged into any other suitable data storage arrangement.

Database 208 and database 210 preferably comprise standard caller identification with name databases as known to those skilled in the art. Databases 210, 214 preferably store information associated with a telephone number that is associated with calling communication station 220. The information associated with the telephone number preferably comprises the identity of a calling party in the form of the calling party's name. Alternatively, the information associated with the telephone number can comprise the identity of a calling party in the form of the calling party's name and the telephone number for calling communication station 220. The telephone number may comprise a 10 digit telephone number but can also comprise any type of identification format used to identify communication stations. Databases 210, 214 can alternatively comprise a caller assistance database as known to those skilled in the art.

Thus, databases 210, 214 form a memory which stores caller identification information and associated name information. The memory may be of any suitable construction or format, such as semiconductor memory, hard disk or otherwise. While databases 208, 210, 214 are depicted within a telecommunications system, databases 208, 210, 214 can comprise any suitable databases containing information adapted for use in the present embodiment and are not limited to databases located within a telecommunications network. It is also important to note that while databases 208, 210, 214 are shown as separate components, they can be implemented as a single database.

Central office 218 preferably comprises an AIN network switch as known to those skilled in the art. Central office 218 enables calls to be placed between calling communication station 220 and called communication station 222. Alternatively, central office 218 can comprise a non-AIN network switch as known to those skilled in the art.

Communication stations 220, 222, 224 preferably comprise analog telephone sets as known to those skilled in the art. Alternatively, communication stations 220, 222, 224 can comprise cellular, wireless, personal communication service (PCS), ISDN or any other form of communication station known to those skilled in the art. Called communication station 222 preferably includes CPE equipment for use with caller identification services as known to those skilled in the art.

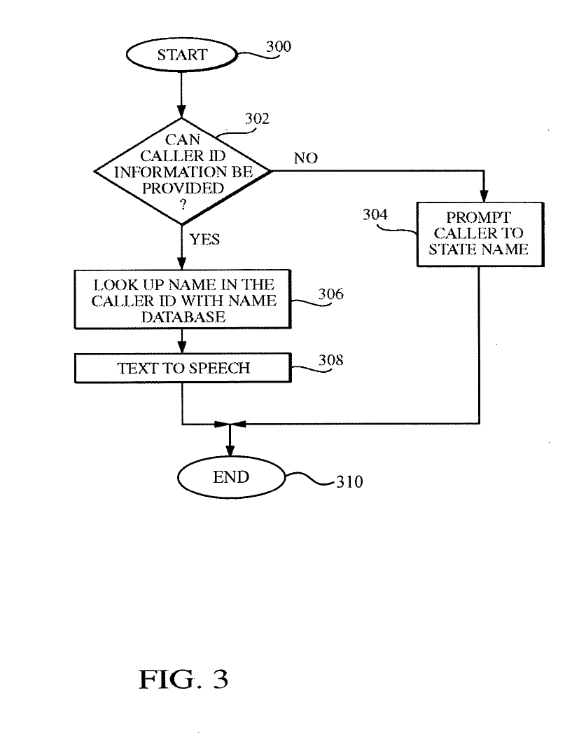

The system 200 depicted in FIGS. 1 and 2 can be utilized to implement the method depicted in FIGS. 3 through 5. For purposes of illustration, a calling party at calling communication station 220 places a call to a customer at called communication station 222. In an attempt to connect the current call, central office 218 routes the current call to SSP 202.

The method of processing a current call from a calling telephone station 220 (FIG. 2) to a called telephone station 222 begins at step 300 of FIG. 3. At step 302, it is determined if standard caller identification information can be provided for the called communication station 222.

In this embodiment, when the call is routed to SSP 202, a terminating attempt trigger is activated when SSP 202 attempts to connect the call to called telephone station 222. The trigger generates a query that is sent to SCP 206. The query preferably includes a calling party identification parameter which can include a calling party presentation restriction indicator and requests the return of standard caller identification information. The telephone number associated with the calling telephone station 220 is included in the calling party identification parameter of the query. SCP 206 receives the query and determines whether or not the called party at called telephone station 222 subscribes to the present service. In response to a determination that the called party subscribes to the present service, SCP 206 analyzes the information included with the query to determine whether standard caller identification information can be provided to called telephone station 222.

Determining whether standard caller identification information can be provided in one embodiment comprises the following steps. The SCP 206 first determines whether standard caller identification information is unavailable. The SCP 206 determines whether the standard Caller ID information is unavailable by determining whether or not the calling party identification parameter is present in the query. In addition, the SCP 206 determines whether the standard caller identification information is incomplete. The SCP 206 preferably determines whether the standard caller identification information is incomplete by determining whether or not the calling party identification parameter is a valid telephone number. In addition, the SCP 206 determines whether the standard caller identification information has been blocked. The SCP 206 determines whether the standard caller identification information has been blocked by determining whether or not the calling party identification presentation restriction indicator is set to “presentation restricted.”

If the standard caller identification information cannot be provided, at step 304 the calling party is prompted to audibly provide spoken caller identification information. SCP 206 accesses database 208 to retrieve call control information and returns the call control information to SSP 202. In response to the call control information, SSP 202 routes the call to SN/IP 212. When SN/IP 212 receives the call, SN/IP 212 generates a request for spoken caller identification information that is transmitted to the calling telephone station 220. The request preferably comprises a statement indicating that the called party doesn't accept calls from unidentified callers and a request for the calling party to speak his/her name and/or the name of the company that they represent. The request preferably comprises an audible message. Alternatively, the request can be displayed on CPE equipment as known to those skilled in the art. If the calling party provides an audible response, SN/IP 212 enables the audible response to be transmitted to called telephone station 222 as audible caller identification information. The audible response may be stored as audible caller identification information, for example at database 214. Alternatively, if the calling party does not provide the requested information, the call is canceled. After prompting for and storing the spoken caller identification information, control proceeds to step 310.

At step 302, if standard caller identification information can be provided for the calling communication station, at step 306 the SCP 206 looks up the calling party's name in the caller identification with name database. This database is stored, for example, at database 210. The system obtains information associated with the calling communication station.

At step 308, audible caller identification information is produced in response to the name data for the calling party. In the illustrated embodiment of FIG. 2, SN/IP 212 implements the text to speech module 216 to generate an audible representation of the name associated with calling communication station 220. Control then proceeds to step 310.

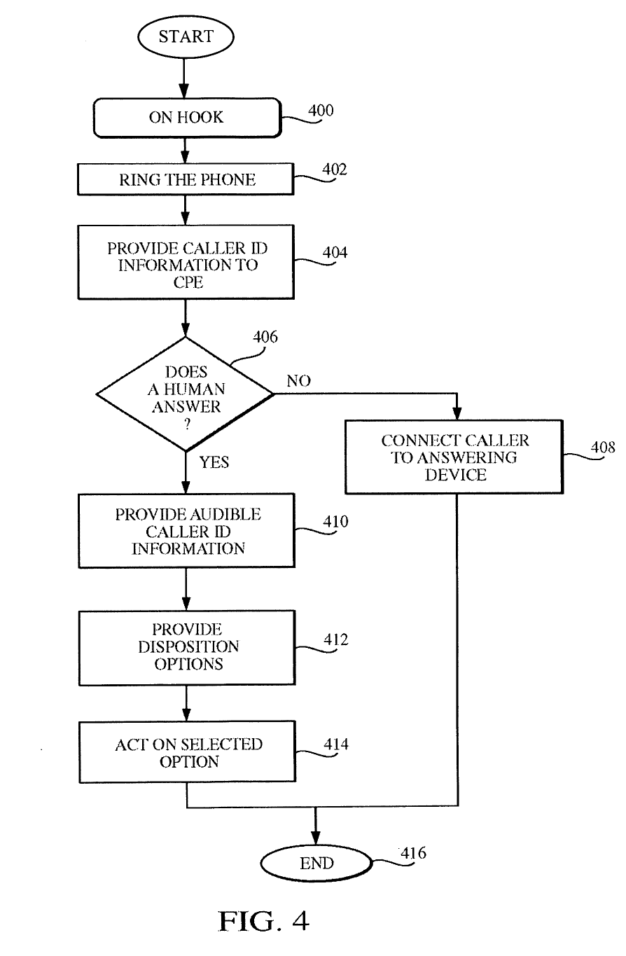

FIG. 4 illustrates call processing to complete the call to the called communication station. At block 400, the system determines that the called communication station 222 is on hook. At step 402, the system rings the called communication station 222. At step 404, the system provides available caller identification information to the CPE. This may be standard caller identification information if that can be provided. This may be indications that the standard caller identification information cannot be provided, such as an indication that the standard caller identification information is unavailable or unknown. In one embodiment, the trade name of the service provider's service is provided to indicate to the called party that the service is processing the call.

At step 406 in the illustrated embodiment, the system determines if the called communication station 222 is being answered by a human. In this manner, the present systems and methods can be configured to work in conjunction with fax machines, answering machines and voice messaging systems. After the called party answers the telephone, a message is transmitted to the called communication station 222 requesting the called party to provide appropriate input to signify that the call is being answered by a human. The message preferably comprises an audible message and is preferably transmitted to the called telephone station 222 by the SN/IP 212. The input can comprise any suitable signal such as DTMF tones, dial pulse input, modem/fax input or voice input as known to those skilled in the art. If the called party provides the requisite input, the audible caller identification information provided by the calling party can be transmitted to the called party. However, if input is not provided within a predetermined amount of time, the audible caller identification information is not transmitted to the called party. Instead, step 408, the calling party can be connected with the answering machine or the voice mail system and the calling party can leave a conventional message. The preferred time period within which the input must be received to prevent the calling party from being connected with the answering machine or voice mail system is three seconds.

Alternatively, if an answering machine or a voice mail system answers the call, the answering machine or voice mail system can immediately transmit a tone input to the SN/IP 212 to signify that the call is not being answered by a human. In response to the input, the SN/IP 212 can connect the calling party to the answering machine or the voice mail system and the calling party can leave a conventional message, step 408. Control proceeds to step 416 where the method for processing the call ends.

If, at step 406, a human answers, at step 410 the audible caller identification information is provided to the called communication station 222. The audible caller identification information may be either the spoken caller identification information that was provided by the calling party or the audible caller identification information produced by the text to speech module 216 converting the standard caller identification information. Alternatively, the calling telephone station 220 and the called telephone station 222 can be connected such that the audible caller identification information can be transmitted between the telephone stations 220, 222. The system provides to the called communication station 222 audible caller identification information using one of standard caller identification information and spoken caller identification information provided by the calling party.

At step 412, after the audible caller identification information has been transmitted, a message is transmitted to called telephone station 222. The message provides disposition options for the call to the called party. The message preferably includes instructions that allow the called party to accept or reject the call by providing the appropriate input. The message preferably comprises audible instructions that are transmitted by SN/IP 212 to called telephone station 222. For example, the called party may be prompted to press 1 on a keypad of the telephone to accept the call, in which case the calling communication station is connected to the called communication station. The called party may be prompted to press 2 to deny the call, in which case the calling party hears only ringing. This is advantageous because the calling party will have no indication that the incoming call was rejected, only an indication that no one was available to answer the call. The called party may be prompted to press 3 to route the call to voice mail, in which case a voice mail greeting is played to the calling party, who is given the option to leave a message for the called party. The called party may be prompted to press 4 to send a sales refusal, in which case the system plays an announcement rejecting the call and requesting no further calls. The called party may alternatively be prompted to press 5 to block the caller, in which case the calling communication station is blocked from ringing the called communication station in the future. Other call disposition options may be provided to suit the needs of particular subscribers, such as residential and business subscribers.

At step 414, in response to input provided by the called party, the SN/IP 212 can process the call. Accordingly, the SN/212 can connect the call, cancel the call, transmit a message to the calling telephone station 220 or forward the call to a voice messaging system or another location in response to the input provided by the calling party. The method for processing the call ends at step 416.

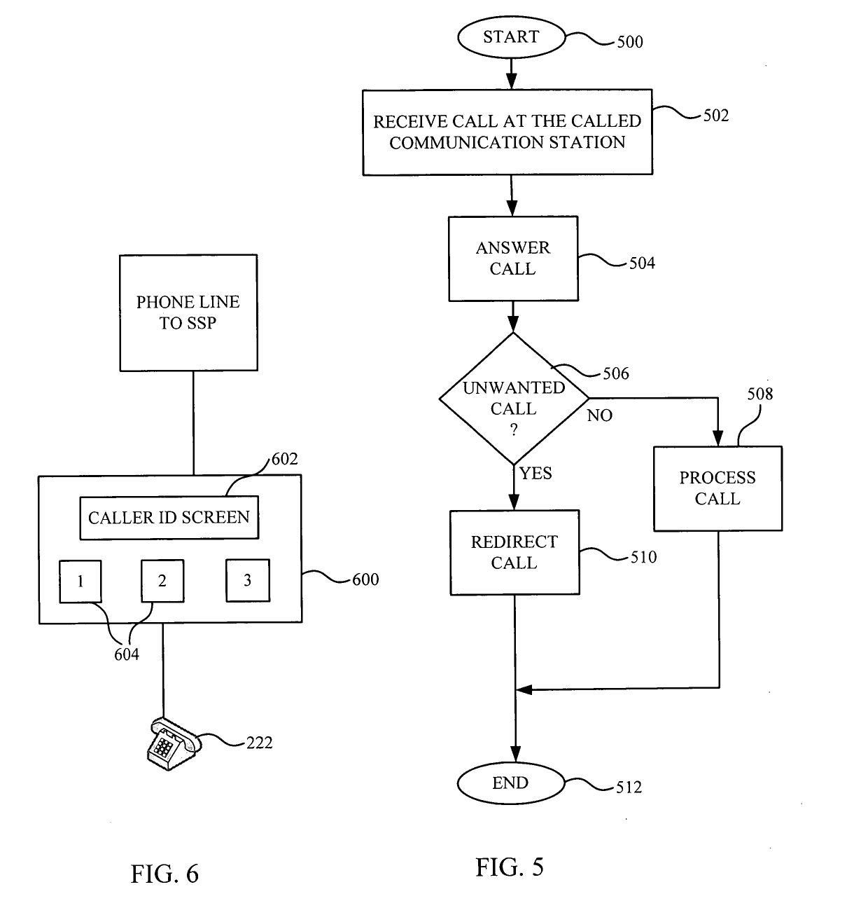

FIG. 5 illustrates further call processing in the case of the call being completed to the called communication station 222. The embodiment illustrated in FIG. 5 provides additional features. This embodiment provides handling of unwanted calls or message-taking once the called party picks up the phone. To activate these options, the called party will either use an adjunct CPE device or use control key sequences on a conventional touchtone phone. The illustrated embodiment begins at block 500.

At block 502, the call is received at the called communication station. In this example, it is assumed that call processing has proceeded generally as described above. That is, a call from a calling communication station for a called communication station was intercepted by the telecommunications system before completion of the call. Subsequently, it was determined if standard calling line identification information can be provided to the called communication station for the call. Then, if standard calling line identification information can not be provided, the calling party at the called communication station is prompted to provide audible calling line identification information. Further, without completing the call between the calling communication station and the called communication station, the called communication station is rung and the audible calling identification information is played to a called party. In response to a call completion indication from the called communication station, the call is completed between the calling communication station and the called communication station.

At block 504, the call is answered by the called party, or the call is otherwise completed by the telecommunication network between the calling communication station and the called communication station. Conventionally, this is achieved by bridging the call from the calling communication station 220 to its serving central office 218 and the call from the SSP 202 to the called communication station 222 (FIG. 2). The SN/IP 212 is withdrawn from the call.

In accordance with the present embodiment of FIG. 5, network equipment continues to monitor the call for to detect key presses or other control information entered or provided by the called party. In a first embodiment, an AIN event is used to control this feature. The SCP 206 activates a T_DTMF_Entered Event when the call is routed to the called party. A T_DTMF_Entered Event is an AIN event in which, when a called party enters DTMF tones, the SCP collects the tones and responds as programmed. Essentially the SCP 206 is monitoring the call for entered digits (can be 0-9, *, #). For example, under control of service logic, the SCP 206 might compare entered digits with predetermined digits of stored control codes to identify a match. When the predetermined digits are encountered, the SCP 206 regains control of the call in response to the match. The called party may disconnect from the call and the SCP 206 will route the call based on the digits entered and the service logic direction (i.e., forward to voicemail, play an announcement, etc.). In this embodiment, the SCP 206 detects a predetermined call redirection indication entered by a party at the called telecommunication station 222 and responds accordingly

In another embodiment, however, the SN/IP 212 monitors the call for non-voice communication from the called communication station. The SN/IP 212 rather than the SCP 206 detects the predetermined call redirection indication entered by the party at the called telecommunication station 222 and responds accordingly.

At block 506, it is determined if the call is an unwanted call. An unwanted call is a call which has been answered but is subsequently deemed to be better handled by an automated action or response. For example, the call is answered but it is intended for a different member of the household. The call is unwanted and should be redirected to voice mail. In another example, the call is a telemarketing or other undesired call. The call is unwanted and the caller should immediately be redirected to a pre-recorded response such as an unwanted sales call, or added to a Do Not Call list, etc.

The party who answered the called communication station in block 504 may provide a redirect indication, indicating that the call is an unwanted call, in any suitable manner. In one exemplary embodiment illustrated in FIG. 6, the called communication station 222 is associated with customer premises equipment (CPE) 600 for interacting with the privacy management system. The CPE 600 is coupled in the telephone line between the called communication station 222 and an SSP, central office or other network device providing subscriber loop service to the called communication station 222. In the illustrated example, the CPE 600 includes a caller ID screen 602 and function keys 604. The caller ID screen 602 may be the screen on which standard caller identification may be displayed when available. The screen 602 may have other uses as well. The function keys 604 have pre-assigned meanings depending on the context of usage. In one example, a first key corresponds to “redirect the call to voice mail;” a second key corresponds to “forward call to pre-recorded message asking to be placed on a Do Not Call list;” and the third key corresponds to “forward call to pre-recorded message indicating that the called party is not accepting the call.” Other functional associations may be made as well between keys and other input devices of the CPE 600 and call disposition options.

In a second exemplary embodiment, the called party who detects an unwanted call enters a control key sequence indicating how the call should be treated. The control key sequence is pressed using the keypad on the called communication station 222 and sends DTMF tones from the called communication station. For example, the control key sequence may be of the form *N, where N is a number from 1 to 3, with the following meanings:
*1 redirect the call to voice mail;
*2 forward call to pre-recorded message asking to be placed on a Do Not Call list;
*3 forward call to pre-recorded message indicating that the called party is not accepting the call
   Any other suitable control key sequences may be substituted, with any other suitable meaning. The meaning or significance of the control key sequence, or of a key press of one of the function keys 604 of the CPE 600, is shared with one or more network elements for subsequently processing the call. The control key sequence or the key press of the function key 604 operates as a call redirection indication entered by the called party at the calling communication station.

The call redirection indication is received for processing by the network equipment. In one example described above, the SN/IP or the SCP continues listening to the call to detect signaling corresponding to the call redirection indication. This may include detecting DTMF tones entered at the called communication station and comparing any received DTMF tones with pre-assigned control codes. If DTMF tones matching a pre-assigned control code are received, indicating that a call redirection indication has been received from the called communication station, the SN/IP or SCP responds by seizing or disconnecting the call between the calling communication station and the called communication station and instead completing the call between the calling communication station and a destination indicated by the call redirection indication. The destination may be identified by the control code, such as voice mail or a message to be played to the calling party by the SN/IP or SCP. The SN/IP is particularly well adapted to receive input from the called communication station, such as DTMF tones, and further process the call by playing messages or redirecting the call. The SN/IP or SCP may listen to or monitor the call during the entire duration of the call for a received call redirection indication. Alternatively, the SN/IP or SCP may monitor only a portion, such as an initial portion such as the first 10 seconds of the call. If no call redirection indication is received during that time, the SN/IP may drop from the call, freeing up the SN/IP for processing other calls.

In other embodiments, other network equipment, such as the SSP or SCP, may perform this function as well using conventional signaling. For example, a service switching point in communication with the called communication station may be operative to analyze a plurality of inputs transmitted from the called communication station during processing of the call. This functionality depends on the call processing logic provided for the SSP. The SSP may further be operative to complete the call between the calling communication station and the called communication station in response to a first input from the called communication and further operative to disconnect the call between the calling communication station and the called communication station and complete the call instead between the calling communication station and a destination indicated by a call redirection indication in response to the call redirection indication. The first input and the call redirection indication have any suitable form, such as a control key sequence, a hook flash, CPE input actuation, etc.

Thus, if the call is an unwanted call based on the call redirection indication provided from the called communication station, block 506, the call is redirected 510 in accordance with the call redirection indication. Otherwise, at block 508, if no indication is received that the call is an unwanted call, the call is processed normally.

While the actions described herein are generally described in conjunction with the components shown in FIG. 2, they can also be implemented using any other suitable components. In general, the systems would operate in the same manner to provide the same or similar functionality as described above.

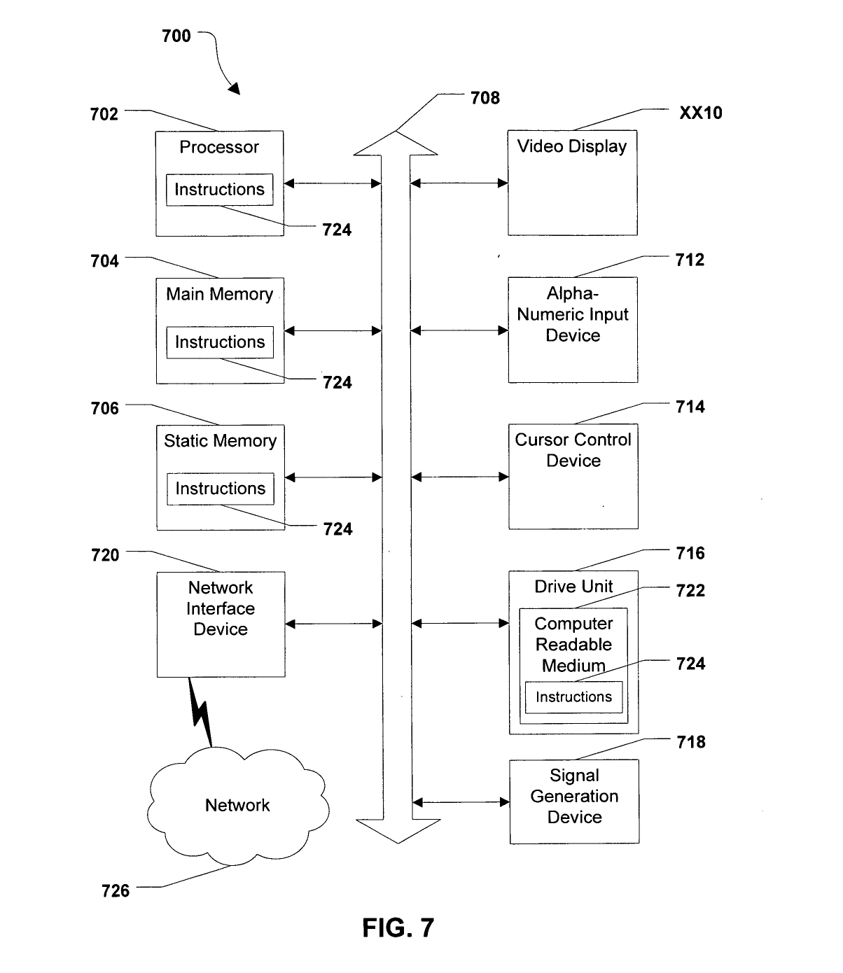

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. For example, in the system of FIG. 2, the SCP 206, the SSP 202 and the SN/IP 212 may all be embodied as computer systems similar to the computer system 700. Adaptation of the general computer system 700 to a specific-purpose computer such as one of the AIN elements of FIG. 2 is well within the purview of the ordinarily skilled artisan. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 700 can be implemented using electronic devices that provide voice, video or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 704 and a static memory 706 that can communicate with each other via a bus 708. As shown, the computer system 700 may further include a video display unit 710, such as a liquid crystal display (LCD), an organic light emitting diode (OLED), a flat panel display, a solid state display, or a cathode ray tube (CRT). Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724 responsive to a propagated signal, so that a device connected to a network 726 can communicate voice, video or data over the network 726. Further, the instructions 724 may be transmitted or received over the network 726 via the network interface device 720.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

From the foregoing, it can be see that the embodiments described herein provide an efficient and effective method and system for handling of unwanted telephone calls. These calls are answered at the called communication, even after passing a privacy management system to ensure that proper caller identification information is available. However, immediately after answering or during the call, it becomes clear to the answering party that the call should be handled with some other automatic disposition. The answering party can enter control key sequences, actuate an adjunct caller premises equipment device, or otherwise send a call redirection indication to the network equipment. This indication is received and the call is suspended, the redirected according to the indication for more suitable processing.

As used herein, the term standard caller identification (Caller ID) information means the information associated with a calling communication station that is typically stored in a database and automatically retrieved and provided to a called party as known to those skilled in the art. As used herein, the term audible caller identification information means audible information provided by the calling party in response to a request for such information. The foregoing specific embodiments are provided to teach and enable those of skill in the art to make and use the invention and to provide a best mode for doing so. The claims and the specific embodiments are not intended to be coextensive.

It is to be understood that a wide range of changes and modifications to the embodiments described above will be apparent to those skilled in the art and are contemplated. It is therefore intended that the foregoing detailed description be regarded as illustrative rather than limiting, and that it be understood that it is the following claims, including all equivalents, that are intended to define the spirit and scope of the invention.

1. A call processing method comprising:
intercepting a call from a calling communication station for a called communication station before completion of the call;
determining if calling line identification information can be provided to the called communication station for the call;
if calling line identification information can not be provided, prompting a calling party at the called communication station to provide audible calling line identification information;
without completing the call between the calling communication station and the called communication station, ringing the called communication station and playing the audible calling identification information to a called party at the called communication station;
in response to a call completion indication from the called communication station, completing the call between the calling communication station and the called communication station;
subsequently, receiving a call redirection indication from the called communication station; and
in response to the call redirection indication, disconnecting the call between the calling communication station and the called communication station and completing the call instead between the calling communication station and a destination indicated by the call redirection indication.

2. The call processing method of claim 1 wherein receiving a call redirection indication comprises:
detecting actuation of customer premises equipment associated with the called communication station; and
associating the detected actuation with redirection of the call to an alternative destination other than the called communication station.

3. The call processing method of claim 1 wherein receiving a call redirection indication comprises:
detecting a control key sequence entered by the called party at the called communication station; and
associating the detected control key sequence with redirection of the call to an alternative destination other than the called communication station.

4. The call processing method of claim 1 further comprising:
in response to the call redirection indication, redirecting the call to voicemail.

5. The call processing method of claim 1 further comprising:
in response to the call redirection indication, forwarding the call to a pre-recorded message asking to place the called party on a Do Not Call list.

6. The call processing method of claim 1 further comprising:
in response to the call redirection indication, forwarding the call to network equipment for playing a pre-defined message to the calling communication station.

7. A system for redirecting an answered call established between a calling communication station and a called communication station, the system comprising:
a service switching point in communication with the called communication station, the service switching point being operative to analyze a plurality of inputs transmitted from the called communication station during processing of the call, the service switching point being operative to complete the call between the calling communication station and the called communication station in response to a first input and operative to disconnect the call between the calling communication station and the called communication station and complete the call instead between the calling communication station and a destination indicated by a call redirection indication in response to the call redirection indication.

8. The system of claim 7 wherein the service switching point is operative to
detect actuation of customer premises equipment associated with the called communication station; and
associate the detected actuation with redirection of the call to an alternative destination other than the called communication station

9. The system of claim 7 further comprising a service control point which is operative to
detect a control key sequence entered by the called party at the called communication station; and
associate the detected control key sequence with redirection of the call to an alternative destination other than the called communication station.

10. A system for redirecting an answered call established between a calling communication station and a called communication station, the system comprising:
a service switching point (SSP) in communication with the called communication station, the service switching point being operative to complete a call between the calling communication station and the called communication station; and
a service node/intelligent peripheral (SN/IP) in communication with the SSP and operative to analyze a plurality of inputs transmitted from the called communication station during processing of the call, the SN/IP further operative to cause the SSP to complete the call in response to a first input from the called communication station indicating the should be accepted and further operative to cause the SSP to disconnect the call from the called communication station and instead redirect the call for completion between the calling communication station and a destination indicated by a call redirection indication detected by the SN/IP from the called communication station.

11. The system of claim 10 wherein the SN/IP is operative to
detect actuation of customer premises equipment associated with the called communication station; and
associate the detected actuation with redirection of the call to an alternative destination other than the called communication station

12. The system of claim 10 wherein the SN/IP is operative to
detect a control key sequence entered by the called party at the called communication station; and
associate the detected control key sequence with redirection of the call to an alternative destination other than the called communication station.

13. The system of claim 12 wherein the SN/IP is operative to detect a plurality of dual tone, multi-frequency key presses at the called communication station as the control key sequence and to compare the detected control key sequence with stored pre-defined control codes.

14. The system of claim 10 wherein the SN/IP is operative to monitor an initial portion of the call after completion between the calling communication station and the called communication station to detect the call redirection indication.

15. The system of claim 10 wherein the SN/IP is operative to monitor substantially the entire call after completion between the calling communication station and the called communication station to detect the call redirection indication.
